(19) United States
(12) Patent Application Publication
(10) Pub. No.: US 2026/0176471 A1
(43) Pub. Date: Jun. 25, 2026

(54) METHOD FOR REGENERATING CARBON BLACKS THROUGH MICROWAVE PYROLYSIS OF WASTE TIRES

(71) Applicants: MEI LIN Holdings Ltd., Kaohsiung City (TW); MEI LIN ENERGY TECHNOLOGY CO., Ltd., Kaohsiung City (TW)

(72) Inventors: Min-Hang Weng, Kaohsiung City (TW); Ru-Yuan Yang, Kaohsiung City (TW)

(73) Assignees: MEI LIN Holdings Ltd., Kaohsiung City (TW); MEI LIN ENERGY TECHNOLOGY CO., Ltd., Kaohsiung City (TW)

(21) Appl. No.: 19/199,335

(22) Filed: May 5, 2025

(30) Foreign Application Priority Data
Dec. 23, 2024 (TW) 113150430

(51) Int. Cl. C09C 1/48; B01J 6/00

(52) U.S. Cl. CPC C09C 1/482; B01J 6/008

(57) ABSTRACT

includes: placing a piece of waste tire into a microwave heating chamber; performing a first microwave heating process to heat the piece of waste tire under an oxygen-free condition within the microwave heating chamber to produce semi-finished carbon blacks and metal wires attached with residual carbons; performing a second microwave heating process to heat the semi-finished carbon blacks and the metal wires under a low-oxygen condition within the microwave heating chamber to produce regenerated carbon blacks and regenerated metal wires; and transferring the regenerated carbon blacks and the regenerated metal wires from the microwave heating chamber to a cooling container for being cooled and then outputted through a conveyor belt.

### CROSS-REFERENCE TO RELATED APPLICATION

This application claims priority to and the benefit of Taiwan Patent Application Ser. No. 113150430, filed on Dec. 23, 2024, the entirety of which is incorporated by reference herein.

### FIELD

The present disclosure relates to a method for regenerating carbon blacks from waste tires, and more particularly to a method for regenerating carbon blacks through microwave pyrolysis of waste tires.

### BACKGROUND

In the world, billions of tires are discarded every year, which has become a major environmental issue. Currently, using waste tires as fuel remains the primary method for handling discarded tires. Burning tires converts resources into energy, which is fast and low-cost, but it cannot recycle valuable materials, leading to continuous resource depletion and secondary pollution.

The composition of tires includes natural rubber, which is the main component of the tire tread layer; synthetic rubber, which is part of the tire tread for cars, trucks, and other vehicles; carbon black and silica, which are used as reinforcing agents to enhance durability; metal and fabric reinforcement wires, which form “tire frame” providing a geometric shape and rigidity; and various chemicals, which achieve unique properties of the tire, such as low rolling resistance or high grip.

Thermal pyrolysis offers a resource recycling economic option for processing waste tires. Pyrolysis plants process recycled tires and waste rubbers obtained from tire factories through pyrolysis to produce valuable carbon black, pyrolysis oil, and steel wires. By degrading waste tires at high temperatures, clean carbon black is obtained while also recovering some organic liquid fuels. However, the reuse of carbon black may be affected by high temperature and surface oxidation.

Microwave heating has three characteristics. 1. Instantaneity: high thermal efficiency and short heating time. 2. Selectivity: different materials have varying dielectric properties, resulting in significant differences in their heating characteristics within the microwave field. 3. Penetration: electromagnetic waves can penetrate the interior of a medium, so the microwaves has strong penetration capability. Many studies have shown that waste materials treated with microwave heating and pyrolysis can produce high-quality recycled materials, achieving the concept of a recycling economy for reuse. Compared to conventional heating technologies, microwave heating technology provides shorter heating times and does not involve direct contact with the heated material, improving the issues of high energy consumption and low efficiency of conventional heating technologies. However, microwave pyrolysis of waste tires is currently still at the laboratory scale. Various processing methods demonstrate that it is feasible to recover regenerated carbon black from waste tires using microwave technology. However, the laboratory methods are often complex and unsuitable for industrial-scale microwave pyrolysis to recover carbon black from waste tires.

Accordingly, it is necessary to provide an industrial-scale, rapid, and environmentally friendly method for regenerating carbon blacks through microwave pyrolysis of waste tires.

### SUMMARY

In order to address the issues mentioned above, the primary objective of the present disclosure is to provide a method for regenerating carbon blacks through microwave pyrolysis of waste tires for the issues and shortcomings of the existing technology. The present method efficiently and uniformly recovers high-value carbon black through microwave pyrolysis of waste tires at lower temperature and under normal pressure. The method enables waste tires to undergo low-temperature pyrolysis and remove surface toxic substances under appropriate microwave power density and in an appropriate air condition, thereby ensuring the integrity of carbon black. In addition, the present method achieves higher recovery rates of carbon black, shortens reaction time, simplifies the reaction process, conserves energy, and enables the recycling of high-quality carbon black while meeting environmental protection requirements.

In order to achieve the objective of the present disclosure, the present disclosure provides a method for regenerating carbon blacks through microwave pyrolysis of waste tires including the steps:
Step (1): Placing a piece of waste tire into a microwave heating chamber, the microwave heating chamber having at least one gas inlet and at least one gas outlet, and the at least one gas outlet being connected to an external extraction device via a pipeline.
Step (2): Performing a first microwave heating process to heat the piece of waste tire under an oxygen-free condition within the microwave heating chamber to produce multiple semi-finished carbon blacks and multiple metal wires attached with residual carbons, wherein the oxygen-free condition is formed by introducing an inert gas into the microwave heating chamber via the at least one gas inlet, and the first microwave heating process is performed at a first temperature between 300° C. and 600° C. for 0.1 to 1 hour.
Step (3): Performing a second microwave heating process to heat the multiple semi-finished carbon blacks and the multiple metal wires attached with the residual carbons under a low-oxygen condition within the microwave heating chamber to produce multiple regenerated carbon blacks and multiple regenerated metal wires, wherein the low-oxygen condition is formed by introducing an oxygen-containing gas into the microwave heating chamber via the at least one gas inlet, and the second microwave heating process is performed at a second temperature between 450° C. and 650° C. for 0.1 to 0.5 hour.
Step (4), Transferring the multiple regenerated carbon blacks and the multiple regenerated metal wires from the microwave heating chamber to a cooling container for being cooled to a third temperature below 200° C. and then outputted through a conveyor belt.

According to one aspect of the present disclosure, the method, in step (1), further includes crushing the piece of waste tire into multiple tire fragments having a length between 5 cm and 30 cm, a width between 5 cm and 30 cm, and a thickness between 2 cm and 10 cm.

According to one aspect of the present disclosure, the at least one gas inlet of the microwave heating chamber is located at a lower half of the ceramic container, and the at least one gas outlet of the microwave heating chamber is located at an upper half of the ceramic container.

According to one aspect of the present disclosure, the first microwave heating process provides a microwave power density that is between 0.1 kW/kg and 2 kW/kg, wherein kg is a unit of weight for the tire fragments.

According to one aspect of the present disclosure, the inert gas introduced in the first microwave heating process is nitrogen with a flow rate ranging from 1 LPM/kg to 10 LPM/kg, wherein LPM is liters per minute (L/min), and kg is a unit of weight for the tire fragments.

According to one aspect of the present disclosure, the external extraction device extracts a gas generated by the multiple semi-finished carbon blacks out of the microwave heating chamber at a first speed greater than or equal to a second speed at which the gas is generated in the first microwave heating process, so that the oxygen-free condition is maintained within the microwave heating chamber.

According to one aspect of the present disclosure, the second microwave heating process provides a microwave power density that is between 0.1 kW/kg and 1 kW/kg, wherein kg is a unit of weight for the tire fragments.

According to one aspect of the present disclosure, the oxygen-containing gas introduced in the second microwave heating process at least includes a compressed air with a flow rate ranging from 1 LPM/kg to 10 LPM/kg, wherein LPM is liters per minute (L/min), and kg is a unit of weight for the tire fragments.

According to one aspect of the present disclosure, the external extraction device extracts the introduced oxygen-containing gas out of the microwave heating chamber at a third speed greater than a fourth speed at which the oxygen-containing gas is introduced into the microwave heating chamber, so that the low-oxygen condition is maintained within the microwave heating chamber.

According to one aspect of the present disclosure, the external extraction device extracts the introduced oxygen-containing gas out of the microwave heating chamber at a third speed equal to a fourth speed at which the oxygen-containing gas is introduced into the microwave heating chamber, so that the low-oxygen condition is maintained within the microwave heating chamber.

The method for regenerating carbon blacks through microwave pyrolysis of waste tires according to the present disclosure provides the following effects:
1. The carbon black and metal wires in waste tires do not need to be removed before microwave pyrolysis. The selective heating characteristics of microwaves allow for the rapid heating of carbon black and metal wires within the waste tires, shortening overall processing time and improving the efficiency and effectiveness of carbon black recovery.
2. Under normal pressure, the inert gas or the oxygen-containing gas is introduced at varying times while maintaining specific temperature controls to degrade organic materials within the waste tires, followed by oxidation reactions, which ensure that the carbon black remains unreated. As a result, the organic materials are effectively removed from the waste tires, thereby obtaining improved carbon black with a smooth surface.
3. The heat released from the oxidation reactions is used for insulation, thereby reducing consumption of microwave power to significantly save energy.
4. The regenerated carbon black obtained from the microwave heating process has excellent properties and can be combined with various organic materials to create new composites applicable in different fields, making the microwave heating process a green and environmentally friendly recycling method.

### BRIEF DESCRIPTION OF THE DRAWINGS

In order to make the above and other objectives, features, and advantages of the present disclosure more apparent and understandable, several preferred embodiments are described below in detail with reference to the accompanying drawings.

FIG. 1 shows a flowchart of a method for regenerating carbon blacks through microwave pyrolysis of waste tires according to the present disclosure.

FIG. 2 shows photos of (a) pieces of waste tires before microwave heating processes, (b) regenerated carbon blacks after microwave heating processes, and (c) regenerated metal wires after microwave heating processes according to one embodiment of the present disclosure.

### DETAILED DESCRIPTION

Although the present disclosure can be embodied in different forms, the drawings and the descriptions herein are the preferred embodiments of the present disclosure. Those skilled in the art will understand that the devices and methods specifically described herein and illustrated in the drawings are considered as examples of the present disclosure and are not limiting exemplary embodiments, and the scope of the present disclosure is defined solely by the claims. The features illustrated or described in connection with one exemplary embodiment can be combined with features of other embodiments. Such modifications and variations will fall within the scope of the present disclosure.

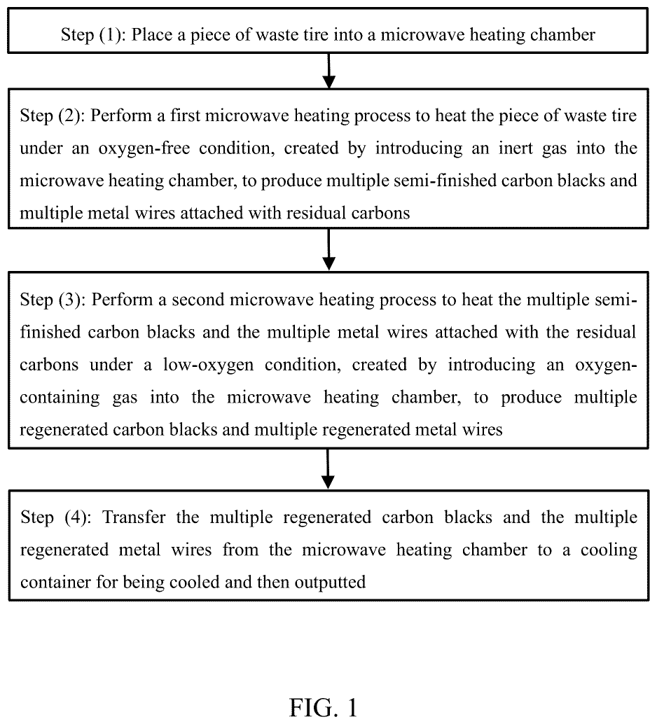

Pyrolysis is a thermochemical reaction process that decomposes organic materials into solid substances, condensed liquids, and combustible gases under high-temperature, oxygen-free, or oxygen-deficient conditions. In order to achieve the objective of the present disclosure, the present disclosure provides a method for regenerating carbon blacks through microwave pyrolysis of waste tires. FIG. 1 shows a flowchart of a method for regenerating carbon blacks through microwave pyrolysis of waste tires according to the present disclosure. The present disclosure provides a method for regenerating carbon blacks through microwave pyrolysis of waste tires including the steps:
Step (1): Placing a piece of waste tire into a microwave heating chamber, the microwave heating chamber having at least one gas inlet and at least one gas outlet, and the at least one gas outlet being connected to an external extraction device via a pipeline. In the present embodiment, a placing device, e.g., a conveyor belt or a robotic arm, can be used to place the piece of waste tire into the microwave heating chamber.

Step (2): Performing a first microwave heating process to heat the piece of waste tire under an oxygen-free condition within the microwave heating chamber to produce multiple semi-finished carbon blacks and multiple metal wires attached with residual carbons, wherein the oxygen-free condition is formed by introducing an inert gas into the microwave heating chamber via the at least one gas inlet, and the first microwave heating process is performed at a first temperature between 300° C. and 600° C. for 0.1 to 1 hour. In the present embodiment, a microwave equipment with a microwave heating chamber can be used to perform the first microwave heating process.

Step (3): Performing a second microwave heating process to heat the multiple semi-finished carbon blacks and the multiple metal wires attached with the residual carbons under a low-oxygen condition within the microwave heating chamber to produce multiple regenerated carbon blacks and multiple regenerated metal wires, wherein the low-oxygen condition is formed by introducing an oxygen-containing gas into the microwave heating chamber via the at least one gas inlet, and the second microwave heating process is performed at a second temperature between 450° C. and 650° C. for 0.1 to 0.5 hour. In the present embodiment, the microwave equipment used for performing the first microwave heating process can then be used to perform the second microwave heating process.

Step (4), Transferring the multiple regenerated carbon blacks and the multiple regenerated metal wires from the microwave heating chamber to a cooling container for being cooled to a third temperature below 200° C. and then outputted through a conveyor belt. In the present embodiment, a transferring device can be used to transfer the multiple regenerated carbon blacks and the multiple regenerated metal wires from the microwave heating chamber into the cooling container.

The composition of tires includes natural rubber, which is the main component of the tire tread layer; synthetic rubber, which is part of the tire tread for cars, trucks, and other vehicles; carbon black and silica, which are used as reinforcing agents to enhance durability; metal and fabric reinforcement wires, which form “tire frame” providing a geometric shape and rigidity; and various chemicals, which achieve unique properties of the tire, such as low rolling resistance or high grip. Natural rubber is an elastic polymer primarily including polyisoprene with the chemical formula [C5H8-]n and also including other non-rubber substances such as proteins, fatty acids, and carbohydrates. Synthetic rubber includes, but is not limited to, styrene-butadiene rubber (SBR), butadiene rubber (BR), nitrile rubber (NBR), chloroprene rubber (CR), ethylene-propylene (Diene) rubber (EP(D)M), isobutylene isoprene rubber (IIR), and isoprene rubber (IR). In addition, specialty synthetic rubber includes, but is not limited to, fluorocarbon rubber (FKM), methyl vinyl silicone rubber (MVQ), silicone rubber (Q), polyurethane rubber (PU), acrylic rubber (ACM), polysulfide rubber (T), chlorinated polyethylene (CPE), chlorosulfonated polyethylene (CSM), chlorinated ether rubber (CO), eco rubber (ECO), chlorinated butadiene rubber (CBR), chloro isobutylene isoprene rubber (CIIR), and epoxidized natural rubber (ENR).

The method, in step (1), further includes crushing the piece of waste tire into multiple tire fragments. The piece of waste tire is an irregular-shaped piece. Since the waste tire is not a homogeneous substance, its different shapes and structures may affect heat transfer, which may further influence the effect of thermal pyrolysis. Therefore, larger waste tires can be crushed, but the carbon black and metal wires therein do not need to be removed, thereby reducing the pre-processing cost of the microwave heating processes. In one embodiment, the larger waste tires can be crushed by mechanical processing. The multiple tire fragments have a length between 5 cm and 30 cm, a width between 5 cm and 30 cm, and a thickness between 2 cm and 10 cm.

In step (1), the microwave heating chamber includes a ceramic container and an outer metal housing covering the ceramic container. The at least one gas inlet is located at a lower half of the ceramic container, and the at least one gas outlet is located at an upper half of the ceramic container. With the at least one gas inlet arranged at the lower half of the ceramic container, airflow can be effectively provided to activate the entire microwave heating process. Multiple microwave power sources are disposed on the outer metal housing and configured to provide microwave power to the tire fragments within the ceramic container of the microwave heating chamber. The required microwave power is determined based on the capacity of microwave heating chamber and the weight of the plastic fragments to be heated. The power of the microwave power sources is adjustable and provides appropriate power density based on the weight of the plastic fragments to be heated. Microwave is an electromagnetic wave that provides a microwave power at a frequency of either 915 MHz or 2450 MHz. The microwave heating process utilizes the principle of radiation, where microwaves enter the interior of the tire fragments through the surfaces of the plastic fragments. The tire fragments then absorbs the energy of the microwaves and converts it into heat, achieving the goal of heating and pyrolysis. The tire fragments are placed into the microwave heating chamber from above and occupy about one-third to two-thirds of the space in the ceramic container of the microwave heating chamber.

In step (2), the first microwave heating process provides a microwave power density that is between 0.1 kW/kg and 2 kW/kg, wherein kg is a unit of weight for the tire fragments. In addition, the inert gas introduced in the first microwave heating process is nitrogen with a flow rate ranging from 1 LPM/kg to 10 LPM/kg, wherein LPM is liters per minute (L/min), and kg is a unit of weight for the tire fragments. It should be noted that the external extraction device extracts a gas generated by the tire fragments out of the microwave heating chamber at a first speed greater than a second speed at which the gas is generated in the first microwave heating process, so that the oxygen-free condition is maintained within the microwave heating chamber. The oxygen-free condition means that there is almost no oxygen present during the microwave heating process. By continuously introducing the inert gas, such as nitrogen or argon, the oxygen inside the microwave heating chamber is completely depleted, and no subsequent oxygen is replenished, achieving a limited air intake design. The flow peed for introducing the inert gas is proportional to a capacity of the microwave heating chamber.

In step (2), the first microwave heating process decomposes the tire fragments into gaseous substances, the semi-finished carbon blacks, and the metal wires attached with the residual carbons. The gaseous substances are extracted from the microwave heating chamber by the external extraction device, and after a subsequent condensation process, the gaseous substances are separated into liquid products, i.e., fuel oil, and gaseous products, i.e., syngas, which primarily include hydrogen, methane, and carbon monoxide. Both the liquid products and gaseous products can be used as energy fuels.

In step (3), the second microwave heating process provides a microwave power density that is between 0.1 kW/kg and 1 kW/kg, wherein kg is a unit of weight for the tire fragments. In addition, the oxygen-containing gas introduced in the second microwave heating process at least includes a compressed air with a flow rate ranging from 1 LPM/kg to 10 LPM/kg, wherein LPM is liters per minute (L/min), and kg is a unit of weight for the tire fragments. It should be noted that the external extraction device extracts the introduced oxygen-containing gas out of the microwave heating chamber at a third speed greater than or equal to a fourth speed at which the oxygen-containing gas is introduced into the microwave heating chamber, so that the low-oxygen condition is maintained within the microwave heating chamber. In other words, the low-oxygen condition refers to a condition in which the amount of oxygen in the microwave heating chamber during the microwave heating process being less than that in normal air. The low-oxygen condition can also be achieved through a restricted air intake design, meaning that during the heating process, air within the heating chamber is only extracted without intaking any gas into the heating chamber during the thermochemical reaction process. Alternatively, the low-oxygen condition can also be achieved by continuously introducing an oxygen-containing gas at least including a compressed air while the external extraction device extracts the introduced oxygen-containing gas out of the microwave heating chamber at a third speed equal to or greater than a fourth speed at which the oxygen-containing gas is introduced into the microwave heating chamber. The flow rate for introducing the oxygen-containing gas is proportional to a capacity of the microwave heating chamber.

In another embodiment, in step (4), the regenerated carbon blacks can be cooled to the third temperature below 200° C. under the low-oxygen condition within the microwave heating chamber and then transferred to the conveyor belt for being outputted. After being cooled to the third temperature below 200° C., the regenerated carbon blacks and the regenerated metal wires can be discharged from the bottom of the microwave heating chamber without being oxidized or burned, and the cooling speed to room temperature can be accelerated.

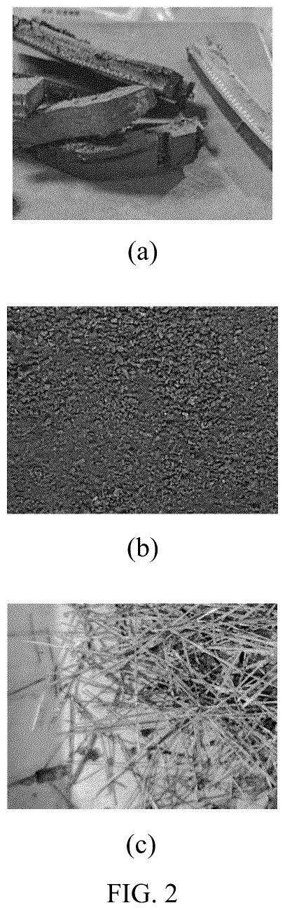

FIG. 2 shows photos of (a) pieces of waste tires before microwave heating processes, (b) regenerated carbon blacks after microwave heating processes, and (c) regenerated metal wires after microwave heating processes according to the present disclosure.

The regenerated carbon blacks outputted from the microwave heating chamber are washed with clean water to remove impurities and then dried to obtain high-quality regenerated carbon blacks.

Since the two-stage microwave heating processes involves different microwave power densities, different heating temperatures, different heating durations, different gases to be introduced, different flow rates of the introduced gas, and different control manners for gas extraction conditions, high-quality regenerated carbon blacks can be effectively produced. The method for regenerating carbon blacks through microwave pyrolysis of waste tires according to the present disclosure provides the following effects:
1. The carbon black and metal wires in waste tires do not need to be removed before microwave pyrolysis. The selective heating characteristics of microwaves allow for the rapid heating of carbon black and metal wires within the waste tires, shortening overall processing time and improving the efficiency and effectiveness of carbon black recovery.
2. Under normal pressure, the inert gas or the oxygen-containing gas is introduced at varying times while maintaining specific temperature controls to degrade organic materials within the waste tires, followed by oxidation reactions, which ensure that the carbon black remains unreated. As a result, the organic materials are effectively removed from the waste tires, thereby obtaining improved carbon black with a smooth surface.
3. The heat released from the oxidation reactions is used for insulation, thereby reducing consumption of microwave power to significantly save energy.
4. The regenerated carbon black obtained from the microwave heating process has excellent properties and can be combined with various organic materials to create new composites applicable in different fields, making the microwave heating process a green and environmentally friendly recycling method.

Although the present disclosure has been disclosed in the preferred embodiments described above, these embodiments are not intended to limit the present disclosure. Any person skilled in the art can make various modifications and changes without departing from the spirit and scope of the present disclosure. As described above, various types of modifications and changes can be made without compromising the spirit of the present disclosure. Therefore, the scope of the present disclosure shall be defined by the appended claims.

What is claimed is:

1. A method for regenerating carbon blacks through microwave pyrolysis of waste tires, the method comprising:
step (1): placing a piece of waste tire into a microwave heating chamber, the microwave heating chamber having at least one gas inlet and at least one gas outlet, and the at least one gas outlet being connected to an external extraction device via a pipeline;
step (2): performing a first microwave heating process to heat the piece of waste tire under an oxygen-free condition within the microwave heating chamber to produce multiple semi-finished carbon blacks and multiple metal wires attached with residual carbons, wherein the oxygen-free condition is formed by introducing an inert gas into the microwave heating chamber via the at least one gas inlet, and the first microwave heating process is performed at a first temperature between 300° C. and 600° C. for 0.1 to 1 hour;
step (3): performing a second microwave heating process to heat the multiple semi-finished carbon blacks and the multiple metal wires attached with the residual carbons under a low-oxygen condition within the microwave heating chamber to produce multiple regenerated carbon blacks and multiple regenerated metal wires, wherein the low-oxygen condition is formed by introducing an oxygen-containing gas into the microwave heating chamber via the at least one gas inlet, and the second microwave heating process is performed at a second temperature between 450° C. and 650° C. for 0.1 to 0.5 hour; and
step (4), transferring the multiple regenerated carbon blacks and the multiple regenerated metal wires from the microwave heating chamber to a cooling container for being cooled to a third temperature below 200° C. and then outputted through a conveyor belt.

2. The method of claim 1, wherein in step (1), further comprising: crushing the piece of waste tire into multiple tire fragments having a length between 5 cm and 30 cm, a width between 5 cm and 30 cm, and a thickness between 2 cm and 10 cm.

3. The method of claim 1, wherein the microwave heating chamber includes a ceramic container and an outer metal housing covering the ceramic container, the at least one gas inlet is located at a lower half of the ceramic container, and the at least one gas outlet is located at an upper half of the ceramic container.

4. The method of claim 1, wherein in step (2), the first microwave heating process provides a microwave power density that is between 0.1 kW/kg and 2 kW/kg, wherein kg is a unit of weight for the tire fragments.

5. The method of claim 1, wherein in step (2), the inert gas introduced in the first microwave heating process is nitrogen with a flow rate ranging from 1 LPM/kg to 10 LPM/kg, wherein LPM is liters per minute (L/min), and kg is a unit of weight for the tire fragments.

6. The method of claim 1, wherein in step (2), the external extraction device extracts a gas generated by the tire fragments out of the microwave heating chamber at a first speed greater than a second speed at which the gas is generated in the first microwave heating process, so that the oxygen-free condition is maintained within the microwave heating chamber.

7. The method of claim 1, wherein in step (3), the second microwave heating process provides a microwave power density that is between 0.1 kW/kg and 1 kW/kg, wherein kg is a unit of weight for the tire fragments.

8. The method of claim 1, wherein in step (3), the oxygen-containing gas introduced in the second microwave heating process at least includes a compressed air with a flow rate ranging from 1 LPM/kg to 10 LPM/kg, wherein LPM is liters per minute (L/min), and kg is a unit of weight for the tire fragments.

9. The method of claim 1, wherein in step (3), the external extraction device extracts the introduced oxygen-containing gas out of the microwave heating chamber at a third speed greater than a fourth speed at which the oxygen-containing gas is introduced into the microwave heating chamber, so that the low-oxygen condition is maintained within the microwave heating chamber.

10. The method of claim 1, wherein in step (3), the external extraction device extracts the introduced oxygen-containing gas out of the microwave heating chamber at a third speed equal to a fourth speed at which the oxygen-containing gas is introduced into the microwave heating chamber, so that the low-oxygen condition is maintained within the microwave heating chamber.
